(19) United States
(12) Patent Application Publication
(10) Pub. No.: US 2026/0170300 A1
(43) Pub. Date: Jun. 18, 2026

(54) METHOD FOR AUTOMATIC PARALLELIZATION OF MIXTURE OF EXPERTS MODEL, DEVICE, AND MEDIUM

(71) Applicant: Beijing Baidu Netcom Science Technology Co., Ltd., Beijing (CN)

(72) Inventors: Yichen Zhang, Beijing (CN); Qiuliang Chen, Beijing (CN); Ruibiao Chen, Beijing (CN); Jinle Zeng, Beijing (CN); Jiabin Yang, Beijing (CN); Dianhai Yu, Beijing (CN); Haifeng Wang, Beijing (CN)

(21) Appl. No.: 19/381,763

(22) Filed: Nov. 6, 2025

(30) Foreign Application Priority Data
Dec. 18, 2024 (CN) 202411875349.X

(51) Int. Cl. G06N 3/045; G06F 16/901

(52) U.S. Cl. CPC G06N 3/045; G06F 16/9024

(57) ABSTRACT

Provided are a method for automatic parallelization of a mixture of experts model, an apparatus for automatic parallelization of a mixture of experts model, a device, a medium, and a program. The method includes acquiring a computational graph of the mixture of experts model; determining a process mesh of an expert weight tensor of an expert model, where the processes are supported to execute by computing devices in the distributed system; splitting a global data tensor into sub-data tensors required by corresponding expert models, and configuring a process mesh of a sub-data tensor to be the same as a process mesh of a corresponding expert model; performing, by the expert model, processing based on an input sub-data tensor and the expert weight tensor to output a sub-result tensor; and determining a result tensor of the mixture of experts model based on at least one sub-result tensor.

### CROSS-REFERENCE TO RELATED APPLICATION

This application claims priority to Chinese Patent Application No. CN 202411875349.X, filed on Dec. 18, 2024, the disclosure of which is incorporated herein by reference in its entirety.

### TECHNICAL FIELD

This disclosure relates to the field of computer technology, and in particular, to deep learning, artificial intelligence, and large-scale model technology.

### BACKGROUND

The mixture of experts (MoE) model is a commonly used large-scale model structure, typically including multiple expert models and a gating network. It aims to handle complex tasks by combining multiple “expert models”, where each expert model is a neural network specializing in solving specific subtasks or aspects of a problem. The gating network is responsible for determining which expert model(s) should process the input data, and the outputs from the expert models are combined to produce the final output.

The MoE model has a massive number of parameters and, when adopting a distributed execution mode, the MoE model can use the computational and storage resources of multiple computing devices to achieve efficient operation. However, since the architectural hierarchies of expert models in an MoE model may be the same or different, implementing automatic parallelization techniques is challenging. Manually setting tensor attributes results in a significant workload, posing obstacles to the rapid distributed execution of the MoE model.

### SUMMARY

This disclosure provides a method for automatic parallelization of a mixture of experts model, an apparatus for automatic parallelization of a mixture of experts model, a device, a medium, and a program product to optimize automatic parallelization techniques for an MoE model.

According to an aspect of this disclosure, a method for automatic parallelization of a mixture of experts model is provided. The method includes steps below.

A computational graph of the mixture of experts model is acquired, where the mixture of experts model includes a gating network and at least two expert models.

A process mesh of an expert weight tensor of an expert model of the at least two expert models is determined, where a process mesh of at least one expert weight tensor includes part of processes in a distributed system used to run the mixture of experts model, and the processes are supported to execute by computing devices in the distributed system.

A global data tensor is split into sub-data tensors required by corresponding expert models, and a process mesh of a sub-data tensor is configured to be the same as a process mesh of a corresponding expert model, where data in the sub-data tensor is data required for processing by the corresponding expert model.

The expert model performs processing based on an input sub-data tensor and the expert weight tensor to output a sub-result tensor.

A result tensor of the mixture of experts model is determined based on at least one sub-result tensor.

According to another aspect of this disclosure, an apparatus for automatic parallelization of a mixture of experts model is provided. The apparatus includes a computational graph acquisition module, a weight tensor process determination module, a data tensor process splitting module, a sub-result output module, and a result tensor determination module.

The computational graph acquisition module is configured to acquire a computational graph of the mixture of experts model, where the mixture of experts model includes a gating network and at least two expert models.

The weight tensor process determination module is configured to determine a process mesh of an expert weight tensor of an expert model of the at least two expert models, where a process mesh of at least one expert weight tensor includes part of processes in a distributed system used to run the mixture of experts model, and the processes are supported to execute by computing devices in the distributed system.

The data tensor process splitting module is configured to split a global data tensor into sub-data tensors required by corresponding expert models and configure a process mesh of a sub-data tensor to be the same as a process mesh of a corresponding expert model, where data in the sub-data tensor is data required for processing by the corresponding expert model.

The sub-result output module is configured to perform, by the expert model, processing based on an input sub-data tensor and the expert weight tensor to output a sub-result tensor.

The result tensor determination module is configured to determine a result tensor of the mixture of experts model based on at least one sub-result tensor.

According to another aspect of embodiments of this disclosure, an electronic device is also provided. The device includes at least one processor and a memory communicatively connected to the at least one processor.

The memory stores instructions executable by the at least one processor. The instructions are executed by the at least one processor to cause the at least one processor to perform the method for automatic parallelization of a mixture of experts model provided by the embodiments of this disclosure.

According to another aspect of embodiments of this disclosure, a non-transitory computer-readable storage medium is also provided. The storage medium stores computer instructions configured to cause a computer to perform the method for automatic parallelization of a mixture of experts model provided by the embodiments of this disclosure.

According to another aspect of embodiments of this disclosure, a computer program product is also provided. The computer program product includes a computer program/instructions that, when executed by a processor, implement the method for automatic parallelization of a mixture of experts model provided by the embodiments of this disclosure.

It is to be understood that the content described in this part is neither intended to identify key or important features of embodiments of this disclosure nor intended to limit the scope of this disclosure. Other features of this disclosure are apparent from the description provided hereinafter.

### BRIEF DESCRIPTION OF DRAWINGS

The drawings are intended to provide a better understanding of the solution and not to limit this disclosure. In the drawings:

FIG. 1 is a flowchart of a method for automatic parallelization of a mixture of experts model according to an embodiment of this disclosure.

FIG. 2 is a flowchart of a method for automatic parallelization of a mixture of experts model according to an embodiment of this disclosure.

FIG. 3 is a diagram illustrating the transformation process of tensor data according to an embodiment of this disclosure.

FIG. 4 is a diagram illustrating the structure of an apparatus for automatic parallelization of a mixture of experts model according to an embodiment of this disclosure.

FIG. 5 illustrates a block diagram of an electronic device according to an embodiment of this disclosure.

### DETAILED DESCRIPTION

Example embodiments of this disclosure, including details of the embodiments of this disclosure, are described hereinafter in conjunction with drawings to facilitate understanding. The example embodiments are illustrative only. Therefore, it is to be recognized by those of ordinary skill in the art that various changes and modifications may be made to the embodiments described herein without departing from the scope and spirit of this disclosure. Similarly, description of well-known functions and constructions is omitted hereinafter for clarity and conciseness.

First, the relevant technologies applicable to the technical solution of this disclosure are introduced.

A distributed system supporting distributed execution of models is a computer cluster consisting of multiple computers, each referred to as a computing node. Each computing node typically includes multiple GPUs (graphics processing units) for performing model computations. A GPU may be referred to as a computing device. One process may control the operation of one GPU. The operator tasks of a model may be assigned to various processes and processed by the corresponding GPUs.

A model computational graph includes various types of operators that conform to the operational logic of the model, such as arithmetic operators, activation function operators, pooling operators, convolution operators, normalization operators, concatenation and splitting operators, and loop operators. To achieve tensor transmission between different computing devices, various communication operators may also be included. The computational graph represents the input and output flow of tensors between operators and annotates the input tensors and the output tensors of the operators with distributed attributes to facilitate parallel processing of computational tasks of the operator across different computing devices. Input tensors include sample data to be processed by the model and transformed feature data, as well as weight parameter matrices required for operator execution. The output tensor after operator processing may serve as the output result or as an input tensor for the next operator.

The same model and distributed system may be designed with different distributed execution modes as needed, and different distributed execution modes may be distinguished and determined by the distributed attributes of a tensor. The distributed attributes of the tensor include the process mesh (also referred to as mesh) and the tensor placement, providing a unified abstract representation for different distributed execution modes.

The process mesh of a tensor indicates which processes the tensor is executed on, that is, which computing devices process the tensor. Thus, the process mesh reflects the organization manner of different processes. Computing devices in a distributed system may be divided based on one or more dimensions, and tensors may also be divided based on the same dimensions in order to be allocated to corresponding processes. For example, a distributed system includes two processes supported by two computing devices, that is, process 0 and process 1. If an input tensor of an operator needs to be input to the two processes and processed by the two processes simultaneously, the process mesh of the tensor is represented as [0, 1]. This indicates that the computational task of the operator is executed on both processes.

The tensor placement indicates the distribution of a tensor across the specified process mesh. The tensor placement generally includes three types, that is, a replicated state (Replicate), a sharded state (Shard(axis)), and a partial state (Partial). The replicated state indicates that the tensor maintains its full state across all processes in the process mesh. The sharded state indicates that the tensor, after being sharded along an axis, is distributed to different processes for processing. If the process mesh is [0, 1] and placements=Shard(0), the tensor is sharded along the row (0th dimension), with the two parts provided to process 0 and process 1, respectively. The partial state indicates that each process holds only part of the values of the tensor and requires a specified reduction operation to recover the full data. If placements=Partial(0), it means that the tensor is sharded along the row, with sharded values provided to the corresponding process, and other parts of the tensor are padded with zeros. It is ensured that each process obtains an entire tensor matrix, albeit with incomplete numerical values. The sharding dimensions of the tensor and the process may be the same, which may be one dimension or two or more dimensions. For example, one dimension may be a row or a column, and two dimensions may include matrix blocks divided by rows and columns. The embodiments of this disclosure do not impose restrictions on this.

The distributed execution mode of a model is actually manifested as the distributed processing of operators, that is, the input tensor of any operator is sharded across the processes of different computing devices for execution, and each process executes part of the computational tasks of the operator. Due to the different computational logic of each operator, requirements for the method of tensor sharding exist, and not all sharding methods can ensure distribution to different processes and correct computation. Moreover, to ensure the correctness of the computational results of the entire model, after the operators perform distributed computation, it may be necessary to insert communication operations into the results to facilitate the exchange of output tensors from multiple processes and transmit the output tensors subjected to operations such as collection or aggregation to subsequent operators for further computation. Thus, the distributed execution mode of the computational graph can be determined by determining the process mesh and tensor placement of each tensor.

In a model computational graph, manually annotating the attributes of all tensors results in a significant workload. Therefore, users typically only need to annotate the process mesh and tensor placements for some tensors of certain operators. Automatic parallelization techniques may then be used. That is, the tensor attributes of other operators are inferred based on the logic between operators represented by the computational graph, and communication operators are automatically inserted to achieve distributed execution of large-scale models without the need to consider details such as distributed strategies or communication between different computing nodes.

The computational graph of an MoE model includes multiple expert models, each of which may be regarded as a collection of operators implementing their own model processing functions. In addition to the operator collections of expert models, other functional operators, such as operator collections of the gating network, are included.

How to employ automatic parallelization techniques to support the distributed execution of the MoE model is a current challenge. The MoE model can deploy different expert models to different processes, which is referred to as the expert model parallel mode. To deploy each expert model to different processes, the process mesh of the input tensors of the operators of the expert model is set to one process, meaning that the operators of the expert model are processed only on the process.

The complexity of annotating tensor attributes in this mode lies in the fact that manually annotating the process mesh and tensor placements of tensors requires significant effort and high expertise. In automatic parallelization techniques, automatic parallelization can be performed only when input tensors of operators have the same process mesh. A feasible approach for performing automatic parallelization techniques based on the computational graph of an MoE model includes three steps.
In step 1, the weight parameters of all expert models are put into the same tensor, which may be referred to as the entire weight tensor.
In step 2, the process mesh and tensor placement are set for the entire weight tensor, which represents that the weight tensors of different expert models are distributed to different processes.
In step 3, the process mesh and distribution attributes of the input data tensor are set. The input data is generally global and should be provided to each expert model. Then the parallel execution of the mixture of experts model is continued.

For the operator collection of any expert model, automatic parallelization can be performed within the operator collection of the expert model and tensor attributes of subsequent operators can be inferred only if the process meshes are the same. However, if the process meshes of the input tensors of the operator collection of an expert model are different, automatic parallelization becomes difficult to implement. For example, for any expert model, if the process mesh of the input data tensor spans all processes, the process mesh of the weight tensor of the expert model also needs to span all processes so that the operator collection of the expert model can perform automatic parallelization. For the operator collection of the expert model, this results in different process meshes of the two input tensors.

However, the preceding technique requires improvement because, to make the weight tensors of the operator collection input to the expert models global, the weight parameters of all expert models need to be combined into a matrix before processing. If the architectures or parameter scales of the expert models differ significantly, combining the parameters into a global matrix is practically challenging. It can be seen that the requirement of the process meshes being the same in the preceding automatic parallelization techniques imposes restrictions on the mixture of experts model.

The technical solution of the embodiments of this disclosure, for the architectural characteristics of the mixture of experts model, provides an optimized technique that reduces restrictions on the architecture of expert models while implementing automatic parallelization of the mixture of experts model.

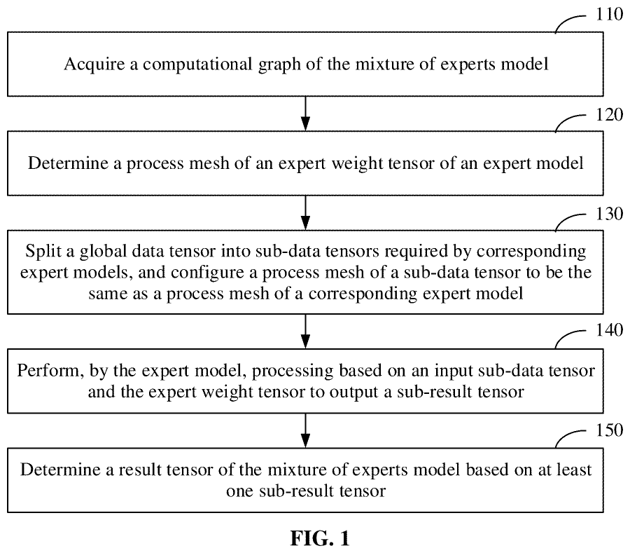

FIG. 1 is a flowchart of a method for automatic parallelization of a mixture of experts model according to an embodiment of this disclosure. This method is applicable to scenarios where the computational graph of a mixture of experts model is used to achieve distributed execution through automatic parallelization techniques, and tensor attributes are inferred through automatic parallelization techniques to enable parallel processing of operators in a distributed system. The method may be executed by an apparatus for automatic parallelization of a mixture of experts model. The apparatus may be implemented in hardware and/or software and configured in an electronic device with computational and storage capabilities, typically a distributed system supporting model distributed execution or an electronic device controlling distributed execution. The method includes S110 to S150.
In S110, a computational graph of the mixture of experts model is acquired, where the mixture of experts model includes a gating network and at least two expert models.
In S120, a process mesh of an expert weight tensor of an expert model is determined, where a process mesh of at least one expert weight tensor includes part of processes in a distributed system used to run the mixture of experts model, and the processes are supported to execute by computing devices in the distributed system. As mentioned above, processes are in a one-to-one correspondence with computing devices.
In S130, a global data tensor is split into sub-data tensors required by corresponding expert models, and a process mesh of a sub-data tensor is configured to be the same as a process mesh of a corresponding expert model, where data in the sub-data tensor is data required for processing by the corresponding expert model.
In S140, the expert model performs processing based on an input sub-data tensor and the expert weight tensor to output a sub-result tensor.
In S150, a result tensor of the mixture of experts model is determined based on at least one sub-result tensor.

As described in the related technology, the computational graph of the mixture of experts model may be acquired first. The mixture of experts model may include a gating network and at least two expert models, as well as other functional modules as needed. The gating network is used to determine, for the input data, at least one expert model to be activated for the current execution and determine part of the input data each expert model should process. For example, the gating network determines, through computing, which expert models should process which input data. For the initial input data, the gating network may output a tensor of shape [E, C, H], where E represents the number of expert models, C represents the amount of data each expert model processes, and H is the vector size of each piece of data. Therefore, by sharding based on the E dimension, the data required by each expert model can be sharded to the operator collection of the expert model for processing. For an expert model that does not need to process data, the value of the data in the corresponding region is usually 0, indicating that no data is provided to the expert model for processing. The manner in which the gating network determines which expert models process which data, and the architecture of each expert model, are not limited in the embodiments of this disclosure and are determined by the specific model functions and training objectives.

For the operator collection of each expert model, execution requires at least the expert weights and the input data to be processed, that is, the expert weight tensor and the data tensor need to be acquired. In the embodiments of this disclosure, the matrix dimensions of the expert weight tensors for each expert model may be the same or different and are determined by the architecture of the expert model itself. In the process of automatic parallelization, the process mesh of the expert weight tensor of at least one expert model is set to include only part of processes. For example, for all processes provided by the distributed system, the process mesh of the expert weight tensor of at least one expert model includes only part of processes. Optionally, different expert models may have process meshes that are not entirely the same. Depending on the operational needs of the expert models, it is actually optional that the process mesh of the expert weight tensor includes one or more processes of the distributed system, and the processes included in the process meshes of different expert weight tensors are partially or entirely the same. It can be seen that various deployment methods for expert models on the processes may exist, and it is not required that the weight tensor of each expert model be unified into an entire weight tensor and that the process mesh of the entire weight tensor be set to include all processes. This restriction is removed so that the architectures of expert models can be the same or different, and the deployment of the expert models across processes becomes more flexible. For example, expert models have the conditions for executing independently in parallel, so for example, the process mesh of each expert weight tensor includes one process, and the process meshes of expert weight tensors are different from each other. This provides greater flexibility in the distributed execution model of expert models in the distributed system.

The distributed execution mode may be determined based on the process mesh of the expert weight tensor of an expert model. The process mesh may be set according to a predefined rule or model operational needs. Optionally, determining the process mesh of the expert weight tensor of the expert model may include acquiring a manually annotated process mesh of the expert weight tensor of the expert model. That is, manual annotation of the process mesh of the expert weight tensor is allowed, which strengthens the control of the model administrators over the execution mode of the model. On the basis of manually defining the distribution mode of the expert model on the processes, the model may still be run using automatic parallelization techniques without requiring extensive manual annotation of other tensor attributes.

Although the expert weight tensors of expert models may have different process meshes, the sample data to be processed of the model, as input data, is typically processed by the gating network operator collection in a global state, which may be referred to as the global data tensor. After the gating network operator collection processes the input data, a global data tensor is obtained and provided to each process so as to be processed. To achieve automatic parallelization of expert models, the process mesh of the global data tensor needs to align with the process mesh of the expert weight tensor. Therefore, the global data tensor needs to be split into sub-data tensors required by corresponding expert models, and the process mesh of a sub-data tensor is configured to be the same as the process mesh of a corresponding expert model. The data in the sub-data tensor is the data required for processing by the corresponding expert model. Optionally, the affiliation relationship between sub-data in the global data tensor and the corresponding expert model is determined by the gating network.

Subsequently, the expert model performs processing based on an input sub-data tensor and the expert weight tensor. Since the process meshes of the sub-data tensor and the expert weight tensor are the same, automatic parallelization techniques can be executed, producing a sub-result tensor output by the expert model. Finally, the final result tensor of the mixture of experts model is determined based on one or more sub-result tensors output by the expert models. For the sub-result tensors, the mixture of experts model may apply additional functional operators to perform post-processing, thus forming the final result tensor.

The technical solution of the embodiments of this disclosure, in the process of executing automatic parallelization techniques for the computational graph of a mixture of experts model, ensures that the process meshes of the expert weight tensor and the sub-data tensor of the expert model are the same, and the process mesh does not have to include all processes of the distributed system. This configuration achieves automatic parallelization of expert models, reduces consistency requirements for the architectures of expert models, and eliminates the need for extensive manual annotation of tensor attributes, thereby making the model functions of the mixture of experts model more flexible. Moreover, automatic parallelization across process meshes is achieved, supporting parallel execution of expert models with different architectures and providing computational advantages for model training or inference processes. Consequently, the computing devices hosting the processes can flexibly implement distributed model execution across process meshes. The execution of the mixture of experts model can fully leverage the hardware advantages of the distributed system, allowing expert models to be deployed on one or more computing devices based on the needs of model execution, without being constrained by automatic parallelization techniques. For example, expert models with different model architectures can be deployed independently on different computing devices. The technical solution of this disclosure is widely applicable to scenarios such as deep learning systems, distributed deep learning systems, machine learning platforms, and distributed training platforms to achieve automatic parallel execution of the mixture of experts model.

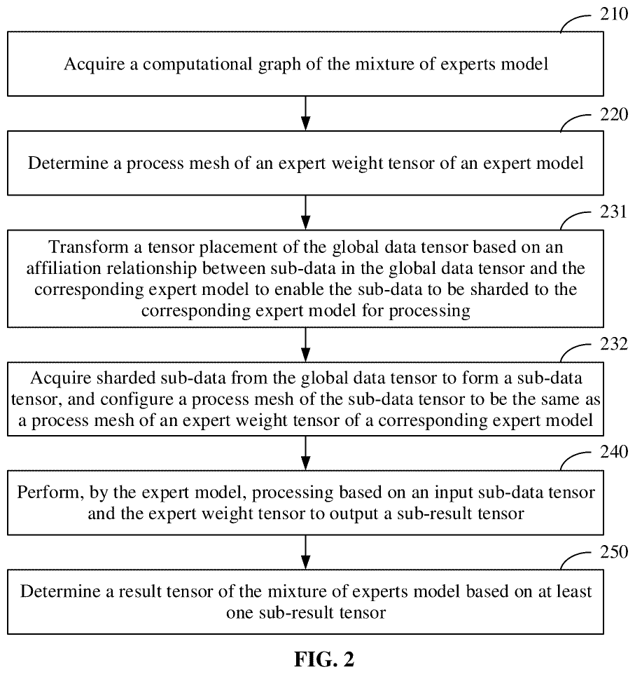

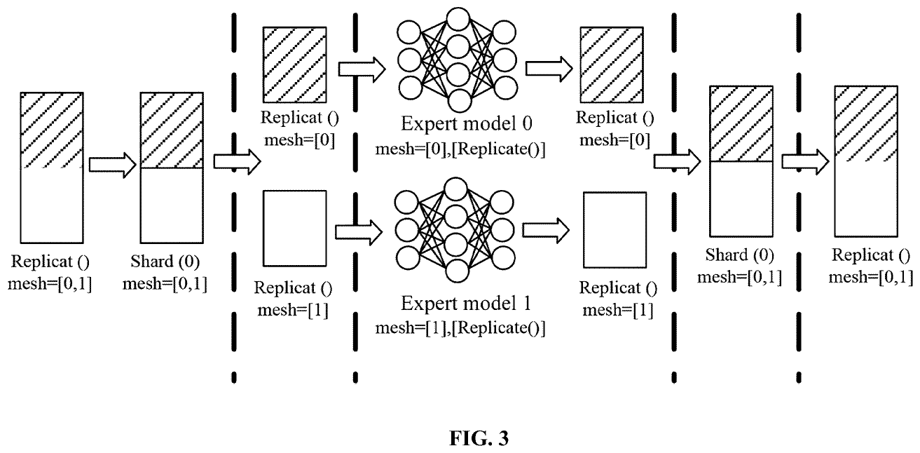

FIG. 2 is a flowchart of a method for automatic parallelization of a mixture of experts model according to an embodiment of this disclosure. FIG. 3 is a diagram illustrating the transformation process of tensor data according to an embodiment of this disclosure. Building on the preceding embodiment, this embodiment provides a specific implementation for changing the process mesh of a tensor, that is, splitting the global data tensor into sub-data tensors required by corresponding expert models can be achieved by adjusting the tensor placement of the sub-data as needed and then setting the process mesh. The method includes S210 to S250.
In S210, a computational graph of the mixture of experts model is acquired, where the mixture of experts model includes a gating network and at least two expert models.
In S220, a process mesh of an expert weight tensor of an expert model is determined, where a process mesh of at least one expert weight tensor includes part of processes in a distributed system used to run the mixture of experts model.
In S231, a tensor placement of the global data tensor is transformed based on an affiliation relationship between sub-data in the global data tensor and the corresponding expert model to enable the sub-data to be sharded to the corresponding expert model for processing.
In S232, sharded sub-data is acquired from the global data tensor to form a sub-data tensor, and a process mesh of the sub-data tensor is configured to be the same as a process mesh of an expert weight tensor of a corresponding expert model, where data in the sub-data tensor is data required for processing by the corresponding expert model.
In S240, the expert model performs processing based on an input sub-data tensor and the expert weight tensor to output a sub-result tensor.
In S250, a result tensor of the mixture of experts model is determined based on at least one sub-result tensor.

For example, the process of splitting the global data tensor into sub-data tensors may include the transformation operation of the tensor placement and the adjustment operation of process meshes. Through the transformation operation of the tensor placement, the sub-data can be sharded to the process of a corresponding expert model, and then the sharded sub-data can form into an independent sub-data tensor, with the process mesh of the independent sub-data tensor configured to be the same as the process mesh of the corresponding expert model.

The following is a detailed description with reference to the accompanying drawings. As shown in FIG. 3, the original process mesh of the global data tensor includes all processes. For illustration, an example is used where two processes, process 0 and process 1, serve as the total processes. The original process mesh of the global data tensor is process mesh=[0, 1]. The data in the global data tensor is provided to each process, so the original tensor placement is in a replicated state, that is, placements=Replicate( ).

The tensor placement of the global data tensor is transformed from a replicated state to a sharded state based on the affiliation relationship between the sub-data in the global data tensor and the corresponding expert model to enable the sub-data to be sharded to the corresponding expert model for processing. As shown in FIG. 3, assuming that after sharding by rows, the first row of sub-data is provided to expert model 0 supported by process 0 and the second row of sub-data is provided to expert model 1 supported by process 1, the tensor placement of the global data tensor is set to a row-based sharded state, that is, placements=Shard(0). For example, the sharding dimension in the sharded state is the same as the process division dimension for running the corresponding expert model. The sharding dimension may be by rows, by columns, or by rows and columns to form partial blocks. The embodiments of this disclosure do not impose restrictions on the sharding dimension, as long as the sub-data tensor can be sharded to the processes of the corresponding expert model.

Although the tensor placement state of the global data tensor has changed, the global data tensor still needs to be sharded into independent sub-data tensors based on the sharded state. As shown in FIG. 3, based on the row-based sharding state, the global data tensor is sharded into two independent sub-data tensors.

Further, after being split into sub-data tensors, these sub-data tensors are provided to the processes of the corresponding expert model, so the process mesh of the sub-data tensors is adjusted to be consistent with the process mesh of the corresponding expert model. As shown in FIG. 3, the process mesh of sub-data tensor 0 for expert model 0 is set to mesh=[0], and the process mesh of sub-data tensor 1 for expert model 1 is set to mesh=[1].

Based on this, the tensor placement of the sub-data tensor may be further inferred and updated to a replicated state or a sharded state based on the process mesh of the sub-data tensor. For example, since the sub-data tensor is provided to the corresponding expert model, the tensor placement of the sub-data tensor is determined based on the processes running the operator collection of the expert model. For example, if the expert model runs on only one process, the sub-data tensor is provided to the one process, and the tensor placement of the sub-data tensor may be in a replicated state. If the expert model runs on multiple processes, the sub-data tensor needs to be in a replicated state or a sharded state to be provided to multiple processes. The tensor placement state of the sub-data tensor is determined by the operational logic of the operator collection of the expert model and is automatically inferred during the automatic parallelization process.

The technical solution of the preceding embodiment achieves the splitting of the global data tensor in a concise adjustment manner by transforming the tensor placement of the global data tensor and setting the process mesh. Thus, it is ensured that consistency between the process meshes of the sub-data tensor and the expert weight tensor, thereby guaranteeing the automatic parallel execution of the mixture of experts model.

Building on the preceding technical solution, the output sub-result tensors may be further processed. For example, determining the result tensor of the mixture of experts model based on at least one sub-result tensor includes aggregating sub-result tensors output by the at least two expert models to form a global result tensor, and modifying a process mesh of the global result tensor to be the same as a process mesh of the global data tensor; and configuring a tensor placement of the global result tensor to a sharded state based on original output processes of sub-result tensors in the global result tensor.

Typically, the process mesh of the sub-result tensor output by each expert model is consistent with the process mesh of the input sub-data tensor. However, the process mesh of the sub-data tensor is not consistent with the process mesh of the global data tensor, which may affect subsequent processing of the data results. After the expert models output results, the mixture of experts model may perform additional post-processing operations on the outputs of the expert models. The specific post-processing functions are not limited in the embodiments of this disclosure, but the global unified post-processing operations of the mixture of experts model require the process mesh of the result tensor to be global. Therefore, it is preferable to restore the process mesh of the sub-result tensor to be consistent with the process mesh of the global data tensor.

For example, as shown in FIG. 3, the specific approach adopted in this embodiment is to first aggregate the two sub-result tensors to form a global result tensor, and then modify the process mesh of the global result tensor to be the same as the process mesh of the global data tensor. For example, the process mesh of sub-result tensor 0 output by expert model 0 is mesh=[0], and the process mesh of sub-result tensor 1 output by expert model 1 is mesh=[1]; after aggregation, the process mesh of the global result tensor is mesh=[0, 1]. Since the original output processes of different sub-result tensors differ, the tensor placement of the global result tensor is set to a sharded state, that is, placements=Shard(0), to indicate the relationship between the sub-results and the corresponding expert models.

In this case, the global result tensor has a global process mesh and may continue to be processed by subsequent operators in the manner of automatic parallelization. Optionally, the method also includes transforming the tensor placement of the global result tensor from a sharded state to a replicated state based on a result output requirement of the mixture of experts model. If the subsequent processing operators of the mixture of experts model require the global result tensor to be provided to each process for processing, the tensor placement of the global result tensor may be transformed from a sharded state to a replicated state. If the output requirement of the mixture of experts model involves outputting the data of the sub-result tensors separately, the tensor placement of the global result tensor may remain in a sharded state. The specific state of the tensor placement may be flexibly determined by the output requirements of the mixture of experts model.

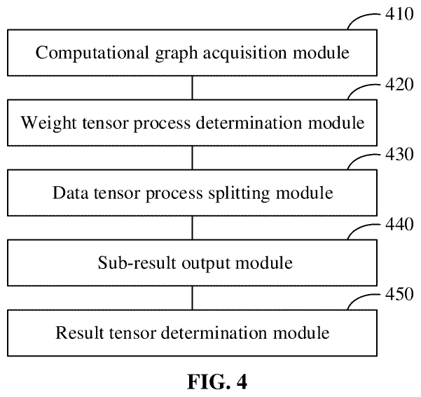

FIG. 4 is a diagram illustrating the structure of an apparatus for automatic parallelization of a mixture of experts model according to an embodiment of this disclosure. The apparatus includes a computational graph acquisition module 410, a weight tensor process determination module 420, a data tensor process splitting module 430, a sub-result output module 440, and a result tensor determination module 450.

The computational graph acquisition module 410 is configured to acquire a computational graph of the mixture of experts model, where the mixture of experts model includes a gating network and at least two expert models.

The weight tensor process determination module 420 is configured to determine a process mesh of an expert weight tensor of an expert model, where a process mesh of at least one expert weight tensor includes part of processes in a distributed system used to run the mixture of experts model, and the processes are supported to execute by computing devices in the distributed system.

The data tensor process splitting module 430 is configured to split a global data tensor into sub-data tensors required by corresponding expert models and configure a process mesh of a sub-data tensor to be the same as a process mesh of a corresponding expert model, where data in the sub-data tensor is data required for processing by the corresponding expert model.

The sub-result output module 440 is configured to perform, by the expert model, processing based on an input sub-data tensor and the expert weight tensor to output a sub-result tensor.

The result tensor determination module 450 is configured to determine a result tensor of the mixture of experts model based on at least one sub-result tensor.

The technical solution of the embodiments of this disclosure, in the process of executing automatic parallelization techniques for the computational graph of a mixture of experts model, ensures that the process meshes of the expert weight tensor and the sub-data tensor of the expert model are the same, and the process mesh does not have to include all processes of the distributed system. This configuration achieves automatic parallelization of expert models, reduces consistency requirements for the architectures of expert models, and eliminates the need for extensive manual annotation of tensor attributes, thereby making the model functions of the mixture of experts model more flexible. Moreover, automatic parallelization across process meshes is achieved, supporting parallel execution of expert models with different architectures and providing computational advantages for model training or inference processes.

Building on the preceding technical solution, optionally, the process mesh of the expert weight tensor in the apparatus includes one or more processes of the distributed system, and the processes included in the process meshes of different expert weight tensors are partially or entirely the same.

Optionally, in the apparatus, a process mesh of each expert weight tensor includes one process, and process meshes of expert weight tensors are different from each other.

Optionally, in the apparatus, the weight tensor process determination module is configured to acquire a manually annotated process mesh of the expert weight tensor of the expert model.

Optionally, in the apparatus. the data tensor process splitting module includes a sub-data sharding unit and a process configuration unit.

The sub-data sharding unit is configured to transform a tensor placement of the global data tensor based on an affiliation relationship between sub-data in the global data tensor and the corresponding expert model to enable the sub-data to be sharded to the corresponding expert model for processing.

The process configuration unit is configured to acquire sharded sub-data from the global data tensor to form a sub-data tensor and configure a process mesh of the sub-data tensor to be the same as a process mesh of an expert weight tensor of a corresponding expert model.

Optionally, in the apparatus, the sub-data sharding unit is configured to transform the tensor placement of the global data tensor from a replicated state to a sharded state based on the affiliation relationship between the sub-data in the global data tensor and the corresponding expert model to enable the sub-data to be sharded to the corresponding expert model for processing.

Optionally, in the apparatus, the data tensor process splitting module also includes a tensor placement updating unit.

The tensor placement updating unit is configured to, after the sharded sub-data is acquired to form the sub-data tensor, update a tensor placement of the sub-data tensor to a replicated state or a sharded state based on the process mesh of the sub-data tensor.

Optionally, in the apparatus, the sharding dimension in the sharded state is the same as the process division dimension for running the corresponding expert model.

Optionally, in the apparatus, the affiliation relationship between sub-data in the global data tensor and the corresponding expert model is determined by the gating network.

Optionally, in the apparatus, the result tensor determination module includes a sub-result aggregation unit and a result placement configuration unit.

The sub-result aggregation unit is configured to aggregate sub-result tensors output by the at least two expert models to form a global result tensor and modify a process mesh of the global result tensor to be the same as a process mesh of the global data tensor.

The result placement configuration unit is configured to configure a tensor placement of the global result tensor to a sharded state based on original output processes of sub-result tensors in the global result tensor.

Optionally, the apparatus also includes a global result tensor placement configuration module.

The global result tensor placement configuration module is configured to transform the tensor placement of the global result tensor from a sharded state to a replicated state based on a result output requirement of the mixture of experts model.

The apparatus for automatic parallelization of a mixture of experts model provided by the embodiments of this disclosure is used to implement the method for automatic parallelization of a mixture of experts model provided by the embodiments of this disclosure and has corresponding functional modules and beneficial effects.

In the technical solution of this disclosure, the collection, storage, use, processing, transmission, provision, and disclosure of user personal information comply with relevant laws and regulations and do not violate public order and good morals.

According to an embodiment of this disclosure, an electronic device, a readable storage medium, and a computer program product are also provided. The electronic device may optionally be used to control a distributed system or serve as a computer in a distributed system and is capable of controlling the operation of each computing device in the distributed system.

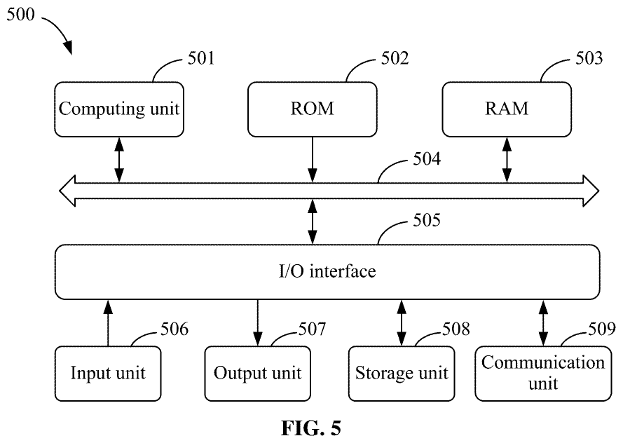

FIG. 5 is a block diagram illustrating an exemplary electronic device 500 that may be configured to perform embodiments of this disclosure. The electronic device is intended to represent various forms of digital computers, for example, a laptop computer, a desktop computer, a workbench, a personal digital assistant, a server, a blade server, a mainframe computer, or another applicable computer. The electronic device may also represent various forms of mobile apparatuses, for example, a personal digital assistant, a cellphone, a smartphone, a wearable device, or a similar computing apparatus. Herein the shown components, the connections and relationships between these components, and the functions of these components are illustrative only and are not intended to limit the implementation of this disclosure as described and/or claimed herein.

As shown in FIG. 5, the device 500 includes a computing unit 501. The computing unit 501 may perform various types of appropriate operations and processing based on a computer program stored in a read-only memory (ROM) 502 or a computer program loaded from a storage unit 508 to a random-access memory (RAM) 503. Various programs and data required for operations of the device 500 may also be stored in the RAM 503. The computing unit 501, the ROM 502, and the RAM 503 are connected to each other by a bus 504. An input/output (I/O) interface 505 is also connected to the bus 504.

Multiple components in the device 500 are connected to the I/O interface 505. The multiple components include an input unit 506 such as a keyboard and a mouse, an output unit 507 such as various types of displays and speakers, the storage unit 508 such as a magnetic disk and an optical disk, and a communication unit 509 such as a network card, a modem or a wireless communication transceiver. The communication unit 509 allows the device 500 to exchange information/data with other devices over a computer network such as the Internet and/or various telecommunications networks.

The computing unit 501 may be various general-purpose and/or special-purpose processing components having processing and computing capabilities. Examples of the computing unit 501 include, but are not limited to, a central processing unit (CPU), a graphics processing unit (GPU), a special-purpose artificial intelligence (AI) computing chip, a computing unit executing machine learning models and algorithms, a digital signal processor (DSP) and any appropriate processor, controller, and microcontroller. The computing unit 501 performs the various methods and processes described above, such as the method for automatic parallelization of a mixture of experts model. For example, in some embodiments, the method for automatic parallelization of a mixture of experts model may be implemented as a computer software program tangibly contained in a machine-readable medium such as the storage unit 508. In some embodiments, part or all of computer programs may be loaded and/or installed on the device 500 via the ROM 502 and/or the communication unit 509. When the computer programs are loaded into the RAM 503 and executed by the computing unit 501, one or more steps of the preceding method for automatic parallelization of a mixture of experts model may be performed. Alternatively, in other embodiments, the computing unit 501 may be configured, in any other suitable manner (for example, by means of firmware), to execute the method for automatic parallelization of a mixture of experts model.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs may be executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Program codes for implementation of the methods of this disclosure may be written in one programming language or any combination of multiple programming languages. The program codes may be provided for the processor or controller of a general-purpose computer, a special-purpose computer, or another programmable data processing apparatus to enable functions/operations specified in flowcharts and/or block diagrams to be implemented when the program codes are executed by the processor or controller. The program codes may be executed entirely on a machine or may be executed partly on a machine. As a stand-alone software package, the program codes may be executed partly on a machine and partly on a remote machine or may be executed entirely on a remote machine or a server.

In the context of this disclosure, the machine-readable medium may be a tangible medium that may include or store a program that is used by or used in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. Concrete examples of the machine-readable storage medium may include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on a computer. The computer has a display apparatus (for example, a cathode-ray tube (CRT) or a liquid-crystal display (LCD) monitor) for displaying information to the user and a keyboard and a pointing apparatus (for example, a mouse or a trackball) through which the user can provide input to the computer. Other types of apparatuses may also be used for providing interaction with a user. For example, feedback provided for the user may be sensory feedback in any form (for example, visual feedback, auditory feedback, or haptic feedback). Moreover, input from the user may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical user interface or a web browser through which a user can interact with implementations of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network, and the Internet.

A computing system may include a client and a server. The client and the server are usually far away from each other and generally interact through the communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related VPS service. The server may also be a server of a distributed system, or a server combined with a blockchain.

Artificial intelligence is the study of making computers simulate certain human thinking processes and intelligent behaviors (such as learning, reasoning, thinking, and planning) both at the hardware and software levels. Artificial intelligence hardware technology generally includes, for example, sensors, special-purpose artificial intelligence chips, cloud computing, distributed storage, and big data processing. Artificial intelligence software technology mainly includes several major directions including computer vision technology, speech recognition technology, natural language processing technology, machine learning/deep learning technology, big data processing technology, and knowledge mapping technology.

Cloud computing refers to a technical system that accesses a shared elastic-and-scalable physical or virtual resource pool through a network, where resources may include servers, operating systems, networks, software, applications, and storage devices and may be deployed and managed in an on-demand, self-service manner by cloud computing. Cloud computing can provide efficient and powerful data processing capabilities for artificial intelligence, the blockchain, and other technical applications and model training.

It is to be understood that various forms of the preceding flows may be used with steps reordered, added, or removed. For example, the steps described in this disclosure may be executed in parallel, in sequence, or in a different order as long as the desired result of the technical solutions provided in this disclosure is achieved. The execution sequence of these steps is not limited herein.

The scope of this disclosure is not limited to the preceding embodiments. It is to be understood by those skilled in the art that various modifications, combinations, subcombinations, and substitutions may be made according to design requirements and other factors. Any modification, equivalent substitution, improvement, and the like made within the spirit and principle of this disclosure falls within the scope of this disclosure.

What is claimed is:

1. A method for automatic parallelization of a mixture of experts model, comprising:
acquiring a computational graph of the mixture of experts model, wherein the mixture of experts model comprises a gating network and at least two expert models;
determining a process mesh of an expert weight tensor of an expert model of the at least two expert models, wherein a process mesh of at least one expert weight tensor comprises part of processes in a distributed system used to run the mixture of experts model, and the processes are supported to execute by computing devices in the distributed system;
splitting a global data tensor into sub-data tensors required by corresponding expert models, and configuring a process mesh of a sub-data tensor of the sub-data tensors to be same as a process mesh of a corresponding expert model, wherein data in the sub-data tensor is data required for processing by the corresponding expert model;
performing, by the expert model, processing based on an input sub-data tensor and the expert weight tensor to output a sub-result tensor; and
determining a result tensor of the mixture of experts model based on at least one sub-result tensor.

2. The method according to claim 1, wherein the process mesh of the expert weight tensor comprises one or more processes of the distributed system, and processes comprised in process meshes of different expert weight tensors are partially or entirely same.

3. The method according to claim 2, wherein a process mesh of each expert weight tensor comprises one process, and process meshes of expert weight tensors are different from each other.

4. The method according to claim 1, wherein determining the process mesh of the expert weight tensor of the expert model comprises:
acquiring a manually annotated process mesh of the expert weight tensor of the expert model.

5. The method according to claim 1, wherein splitting the global data tensor into the sub-data tensors required by the corresponding expert models and configuring the process mesh of the sub-data tensor to be same as the process mesh of the corresponding expert model comprises:
transforming a tensor placement of the global data tensor based on an affiliation relationship between sub-data in the global data tensor and the corresponding expert model to enable the sub-data to be sharded to the corresponding expert model for processing; and
acquiring sharded sub-data from the global data tensor to form a sub-data tensor, and configuring a process mesh of the sub-data tensor to be same as a process mesh of an expert weight tensor of a corresponding expert model.

6. The method according to claim 5, wherein transforming the tensor placement of the global data tensor based on the affiliation relationship between the sub-data in the global data tensor and the corresponding expert model to enable the sub-data to be sharded to the corresponding expert model for processing comprises:
transforming the tensor placement of the global data tensor from a replicated state to a sharded state based on the affiliation relationship between the sub-data in the global data tensor and the corresponding expert model to enable the sub-data to be sharded to the corresponding expert model for processing.

7. The method according to claim 6, wherein after the sharded sub-data is acquired to form the sub-data tensor, the method further comprises:
updating a tensor placement of the sub-data tensor to a replicated state or a sharded state based on the process mesh of the sub-data tensor.

8. The method according to claim 6, wherein a sharding dimension in the sharded state is same as a process division dimension for running the corresponding expert model.

9. The method according to claim 1, wherein an affiliation relationship between sub-data in the global data tensor and the corresponding expert model is determined by the gating network.

10. The method according to claim 1, wherein determining the result tensor of the mixture of experts model based on the at least one sub-result tensor comprises:
aggregating sub-result tensors output by the at least two expert models to form a global result tensor, and modifying a process mesh of the global result tensor to be same as a process mesh of the global data tensor; and
configuring a tensor placement of the global result tensor to a sharded state based on original output processes of sub-result tensors in the global result tensor.

11. The method according to claim 10, further comprising:
transforming the tensor placement of the global result tensor from the sharded state to a replicated state based on a result output requirement of the mixture of experts model.

12. The method according to claim 10, further comprising:
transforming the tensor placement of the global result tensor from the sharded state to a replicated state based on a result output requirement of the mixture of experts model.

13. An electronic device, comprising:
at least one processor; and
a memory communicatively connected to the at least one processor;
wherein the memory stores instructions executable by the at least one processor, and the instructions are executed by the at least one processor to cause the at least one processor to perform the following steps:
acquiring a computational graph of a mixture of experts model, wherein the mixture of experts model comprises a gating network and at least two expert models;
determining a process mesh of an expert weight tensor of an expert model of the at least two expert models, wherein a process mesh of at least one expert weight tensor comprises part of processes in a distributed system used to run the mixture of experts model, and the processes are supported to execute by computing devices in the distributed system;
splitting a global data tensor into sub-data tensors required by corresponding expert models, and configuring a process mesh of a sub-data tensor of the sub-data tensors to be same as a process mesh of a corresponding expert model, wherein data in the sub-data tensor is data required for processing by the corresponding expert model;
performing, by the expert model, processing based on an input sub-data tensor and the expert weight tensor to output a sub-result tensor; and
determining a result tensor of the mixture of experts model based on at least one sub-result tensor.

14. The electronic device according to claim 13, wherein the process mesh of the expert weight tensor comprises one or more processes of the distributed system, and processes comprised in process meshes of different expert weight tensors are partially or entirely same.

15. The electronic device according to claim 14, wherein a process mesh of each expert weight tensor comprises one process, and process meshes of expert weight tensors are different from each other.

16. The electronic device according to claim 13, wherein determining the process mesh of the expert weight tensor of the expert model comprises:
acquiring a manually annotated process mesh of the expert weight tensor of the expert model.

17. The electronic device according to claim 13, wherein splitting the global data tensor into the sub-data tensors required by the corresponding expert models and configuring the process mesh of the sub-data tensor to be same as the process mesh of the corresponding expert model comprises:
transforming a tensor placement of the global data tensor based on an affiliation relationship between sub-data in the global data tensor and the corresponding expert model to enable the sub-data to be sharded to the corresponding expert model for processing; and
acquiring sharded sub-data from the global data tensor to form a sub-data tensor, and configuring a process mesh of the sub-data tensor to be same as a process mesh of an expert weight tensor of a corresponding expert model.

18. The electronic device according to claim 17, wherein transforming the tensor placement of the global data tensor based on the affiliation relationship between the sub-data in the global data tensor and the corresponding expert model to enable the sub-data to be sharded to the corresponding expert model for processing comprises:
transforming the tensor placement of the global data tensor from a replicated state to a sharded state based on the affiliation relationship between the sub-data in the global data tensor and the corresponding expert model to enable the sub-data to be sharded to the corresponding expert model for processing.

19. The electronic device according to claim 18, wherein after the sharded sub-data is acquired to form the sub-data tensor, the at least one processor is further caused to perform the following step:
updating a tensor placement of the sub-data tensor to a replicated state or a sharded state based on the process mesh of the sub-data tensor.

20. A non-transitory computer-readable storage medium storing computer instructions for causing a computer to perform the following steps:
acquiring a computational graph of a mixture of experts model, wherein the mixture of experts model comprises a gating network and at least two expert models;
determining a process mesh of an expert weight tensor of an expert model of the at least two expert models, wherein a process mesh of at least one expert weight tensor comprises part of processes in a distributed system used to run the mixture of experts model, and the processes are supported to execute by computing devices in the distributed system;
splitting a global data tensor into sub-data tensors required by corresponding expert models, and configuring a process mesh of a sub-data tensor of the sub-data tensors to be same as a process mesh of a corresponding expert model, wherein data in the sub-data tensor is data required for processing by the corresponding expert model;
performing, by the expert model, processing based on an input sub-data tensor and the expert weight tensor to output a sub-result tensor; and
determining a result tensor of the mixture of experts model based on at least one sub-result tensor.
